(19) United States
(12) Patent Application Publication
(10) Pub. No.: US 2007/0058089 A1
(43) Pub. Date: Mar. 15, 2007

(54) Projection type display device and method for controlling the same

(75) Inventor: Do San Wang, Seo-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/316,924

(22) Filed: Dec. 27, 2005

(30) Foreign Application Priority Data
Sep. 9, 2005 (KR) 10-2005-0084098

(51) Int. Cl. H04N 3/27

(52) U.S. Cl. 348/744; 348/554

(57) ABSTRACT

A projection type display device and a method for controlling the same are disclosed which are capable of preventing a reduction in the brightness of video caused by an ineffective region. The method includes the steps of determining effective and ineffective video regions of video based on a brightness of an input video signal, calculating an average brightness value of the effective video region, and controlling an optical output of the projection type display device based on the calculated average luminance value.

This application claims the benefit of Korean Patent Application No. 10-2005-0084098, filed on Sep. 9, 2005, which is hereby incorporated by reference as if fully set forth herein.

### BACKGROUND OF THE INVENTION

1. Field of the Invention

The present invention relates to a display device, and more particularly, to a projection type display device and a method for controlling the same, which are capable of accurately controlling the brightness of an image to be displayed.

2. Discussion of the Related Art

Generally, projection type display devices are appliances which realize a large screen using a principle of projecting an image on a screen by use of mirrors and a projection lens. Such projection type display devices are mainly classified into a cathode ray tube (CRT) optical unit, a liquid crystal display (LCD) optical unit, a digital light processing (DLP) optical unit, and a liquid crystal on silicon (LCOS) optical unit.

FIG. 1 is a view of images displayed in diverse display modes, illustrating effective and ineffective regions of each image. Projection type display devices can display an image in diverse display modes. Referring to FIG. 1, there are ineffective regions (e.g., black bars or black voids) at left and right sides of a screen in a 4:3 mode. The ineffective regions are regions where no actual image is displayed. The ineffective regions are exhibited in the form of black regions because no video signals are supplied to pixels corresponding to the ineffective regions. In a TWIN mode or a movie mode, ineffective regions are exhibited at upper and lower edges or sides of a screen. In a personal computer (PC) mode, there are ineffective regions at upper, lower, left and right sides.

In a conventional projection type display device, gray information of the entire portion of the screen is used to extract histogram data for control of the optical power of the projection type display device. That is, gray information of all dots in the screen is detected, and histogram data is produced based on the detected gray information. In such a conventional case, however, the brightness of the image displayed on the screen is lower than a brightness set for the image because the optical power of the projection type display device is controlled based on the average gray value of the entire portion of the screen. For this reason, when the area of ineffective regions is increased, as in the PC mode, the lowering of the brightness of the image displayed on the screen becomes more severe.

### SUMMARY OF THE INVENTION

Accordingly, the present invention is directed to a projection type display device and a method for controlling the same that substantially obviate one or more problems due to limitations and disadvantages of the related art.

An object of the present invention is to provide a projection type display device and a method for controlling the same which are capable of preventing a reduction in image brightness caused by an ineffective region.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a projection type display device comprises the steps of: determining effective and ineffective video regions of video based on a brightness of an input video signal; calculating an average brightness value of the effective video region; and controlling an optical output of the projection type display device based on the calculated average luminance value.

The step of determining the effective and ineffective video regions of video based on the brightness of the input video signal may comprise the steps of comparing the brightness of the video signal with a reference brightness for each pixel of the video signal, and determining the pixel to be an effective video region or an ineffective video region, based on the results of the comparison.

The step of determining the effective and ineffective video regions of video based on the brightness of the input video signal may comprise the steps of comparing an average brightness value of each frame of the video signal with a reference brightness, and determining the frame to be an effective video region or an ineffective video region, based on the results of the comparison.

The step of determining the effective and ineffective video regions of video based on the brightness of the input video signal may comprise the steps of sampling brightness values of a part of pixels in each frame of the video signal, comparing the brightness values of the sampled pixels with a reference brightness, and determining the frame to be an effective video region or an ineffective video region, based on the results of the comparison. The step of sampling brightness values of a part of pixels in each frame of the video signal may comprise the steps of calculating an average value of the brightness values of the sampled pixels, and comparing the calculated average value with the reference brightness.

In another aspect of the present invention, a projection type display device comprises: an optical power controller for adjusting an optical power for display of video; and a controller for determining effective and ineffective video regions of video based on a brightness of an input video signal, and controlling the optical power of the optical power controller based on an average brightness value of the effective video region.

In another aspect of the present invention, a method for controlling a projection type display device comprises the steps of: determining an effective video region of input video; calculating a ratio of the effective video region to the entire region of the input video; and controlling an optical power for display of the video, based on the calculated ratio.

The step of calculating the ratio of the effective video region to the entire video region may comprise the step of calculating the ratio of the effective video region to the entire video region based on the number of system clocks in a period of the entire video region and the number of system clocks in a period of the effective video region, or calculating the ratio of the effective video region to the entire video region based on the number of vertical or horizontal scan lines in a period of the entire video region and the number of vertical or horizontal scan lines in a period of the effective video region.

The step of controlling the optical power for display of the video based on the calculated ratio may comprise the steps of multiplying an average luminance value of the entire region of the video by the calculated ratio, and controlling the optical power for display of the video, based on a value obtained in accordance with the multiplication.

In another aspect of the present invention, a projection type display device comprises: an optical power controller for controlling an optical power for display of input video; and a controller for determining an effective video region of the input video, calculating a ratio of the effective video region to the entire region of the input video, and controlling the optical power for display of the video, based on the calculated ratio.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of images displayed in diverse display modes, illustrating effective and ineffective regions of each image;

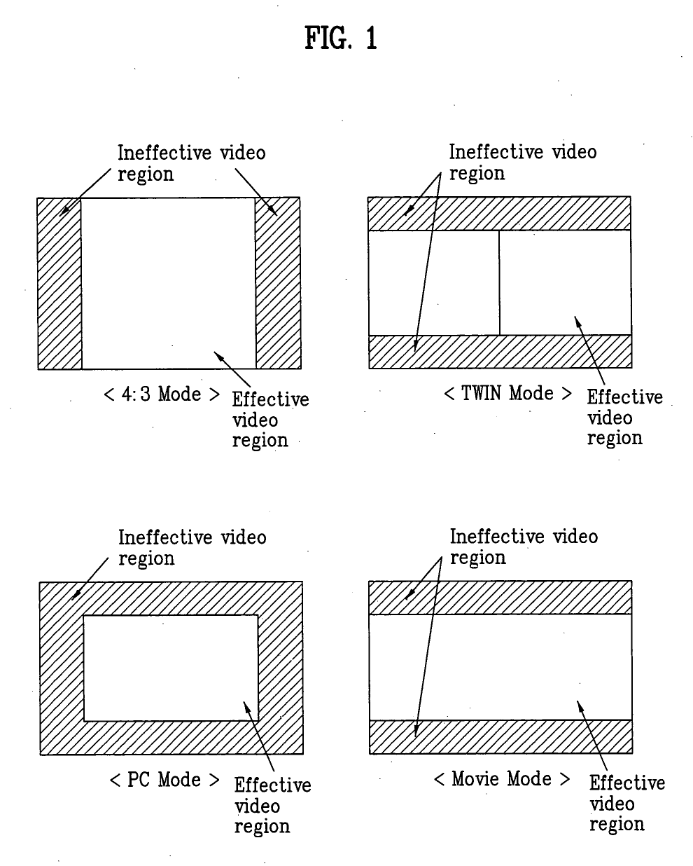

FIG. 2 is a block diagram illustrating an exemplary embodiment of a projection type display device according to the present invention;

FIG. 3 is a waveform diagram of signals used in the present invention;

FIG. 4 is a flow chart explaining a method for controlling the projection type display device in accordance with a first embodiment of the present invention; and

FIG. 5 is a flow chart explaining a method for controlling the projection type display device in accordance with a second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

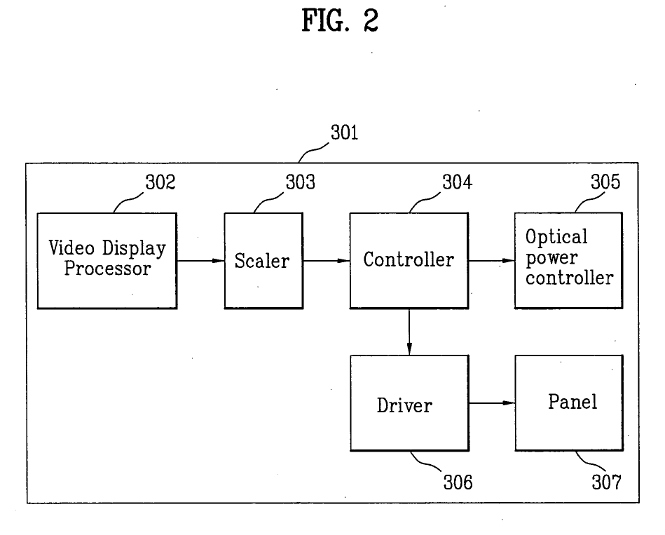

FIG. 2 is a block diagram illustrating an exemplary embodiment of a projection type display device according to the present invention. FIG. 2 shows only the constituent elements of the projection type display device essentially required to accomplish the object of the present invention, without showing general constituent elements required to receive and display broadcast signals. Although the illustration and description of the general constituent elements of the projection type display device are omitted, these general constituent elements will be apparently appreciated by those skilled in the technical field.

The projection type display device may include a CRT optical unit, an LCD optical unit, a DLP optical unit, or an LCOS optical unit.

Referring to FIG. 2, a broadcast signal of a 1080i format or a signal from an external appliance is inputted to the projection type display device through a video processor 302. The external appliance may include a personal video recorder (PVR), a DVD player, a PC, and a set-top box. FIG. 2 illustrates a video display processor (VDP) as an example of the video processor 302.

A 1080i-format video signal output from the video processor 302 is applied to a scaler 303 which converts the video signal of the 1080i format to a video signal of a 1080p format. Where the video signal output from the scaler 303 is a video signal having the 1080i format, scanning of video to be displayed is carried out such that the video is simultaneously scanned to odd and even fields of the screen. On the other hand, where the video signal output from the scaler 303 is a video signal having the 1080p format, scanning of video to be displayed is carried out such that the video is alternately scanned to the odd and even fields of the screen.

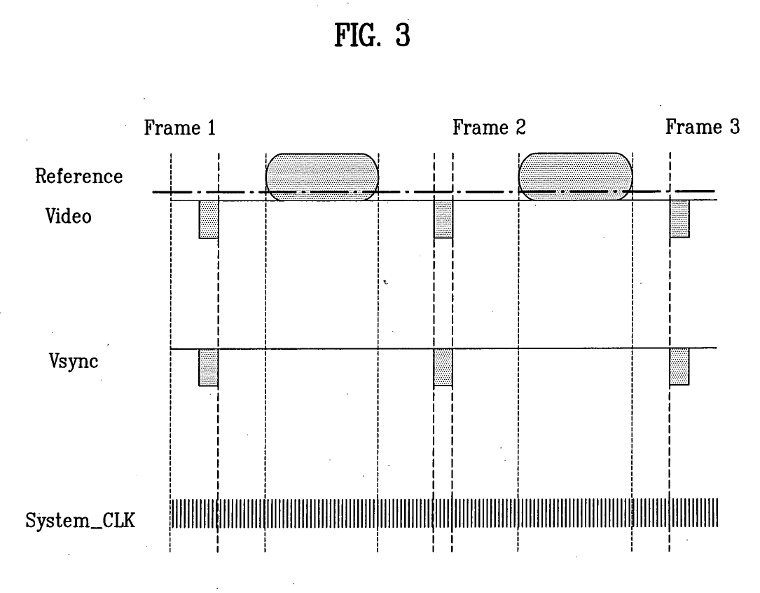

The 1080p-format video signal output from the scaler 303 is applied to a controller 304. The controller 304 determines effective and ineffective video regions of the video to be displayed on a panel 307, based on the brightness value of the applied video signal. As shown in FIG. 3, the controller 304 compares the brightness value of the video signal with a reference brightness value to determine the effective and ineffective video regions, as shown in FIG. 3. The controller 304 produces a histogram based on the brightness value of the effective video region, and calculates an average brightness value of the effective video region based on the produced histogram. Alternatively, the controller 304 may produce a histogram base on the ratio of the effective video region to the entire video region. The histogram is data used to control the brightness of video to be displayed. Thus, the controller 304 controls the optical power of the optical power controller 305 based on the average brightness value of the effective video region and the ratio of the effective video region to the entire video region. The controller 304 outputs a pulse width modulation (PWM) signal to control the optical power controller 305.

The optical power controller 305 is arranged in front of an optical projection lens, to control the amount of emission light under the control of the controller 304, and thus, to control the brightness of video. An example of the optical power controller 305 according to the present invention is a contrast enhancement aperture. In order to drive the panel 307, a panel timing signal is generated from a panel driver 306. The panel driver 306 outputs the panel timing signal to the panel 307, together with the video signal.

Hereinafter, embodiments of a method for controlling the projection type display device according to the present invention will be described.

First Embodiment

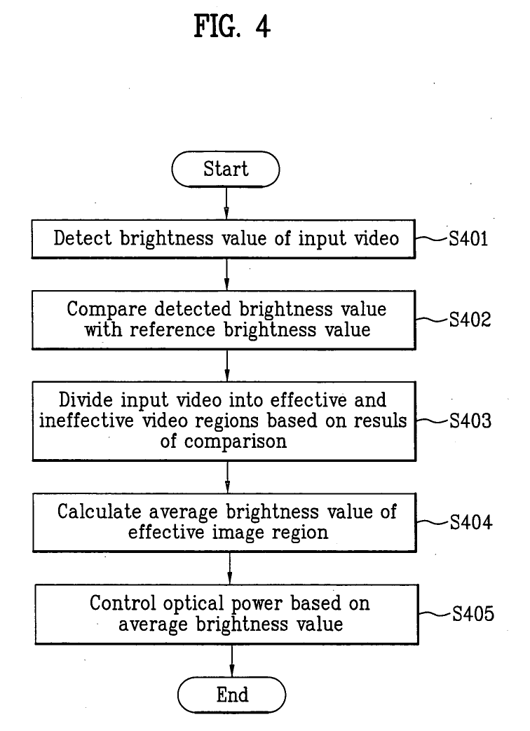

FIG. 4 is a flow chart explaining a method for controlling the projection type display device in accordance with a first embodiment of the present invention. When a video signal from a broadcasting station or from an external appliance, the controller 304 detects the brightness value of the received video signal (S401), and compares the detected brightness value with a reference brightness value (S402). In this case, the controller 304 may perform the detection and comparison of the brightness value of the video signal for each pixel, may perform the detection and comparison of the brightness value (average brightness value) of the video signal for each frame, or may perform sampling of the brightness values of a part of pixels in each frame of the video signal, and comparison of the sampled brightness values with a reference brightness value.

If the brightness value of the video signal associated with a pixel or frame is not lower than the reference brightness value, the controller 304 determines that the pixel or frame is an effective video region. On the other hand, if the brightness value of the video signal associated with the pixel or frame is lower than the reference brightness value, the controller 304 determines that the pixel or frame is an ineffective video region. For example, when the reference brightness value is set to 15 in the case in which data representing brightness has a range of 1,024, the video signal having a brightness value lower than 15 is determined to be an ineffective video region. The controller 304 determines the effective and ineffective video regions of the video based on the brightness value of the video signal.

The controller 304 also determines the number of vertical synchronizing signals V-sync generated during input of a video signal having a brightness value lower than the reference brightness value, to determine the pixels or frames of the video signal as ineffective video regions only when the number of the vertical synchronizing signals V-sync is higher than a predetermined value. This is because, even when the brightness value of one frame is lower than the reference brightness value, the frame may be an ineffective region.

After the determination of the effective and ineffective video regions, the controller 304 produces a histogram based on the brightness value for each pixel or each frame corresponding to the effective video region, and calculates an average brightness value of the effective video region based on the produced histogram (S404). For the calculation of the average brightness value of the effective video region, the controller 304 uses the previously-detected brightness value for each pixel or each frame.

Thereafter, the controller 304 controls the optical power of the optical power controller 305 based on the average brightness value of the effective video region (S405). For example, when the average brightness value of the effective video region is high, the controller 304 increases the optical power of the optical power controller 305. On the other hand, when the average brightness value of the effective video region is low, the controller 304 decreases the optical power of the optical power controller 305.

Second Embodiment

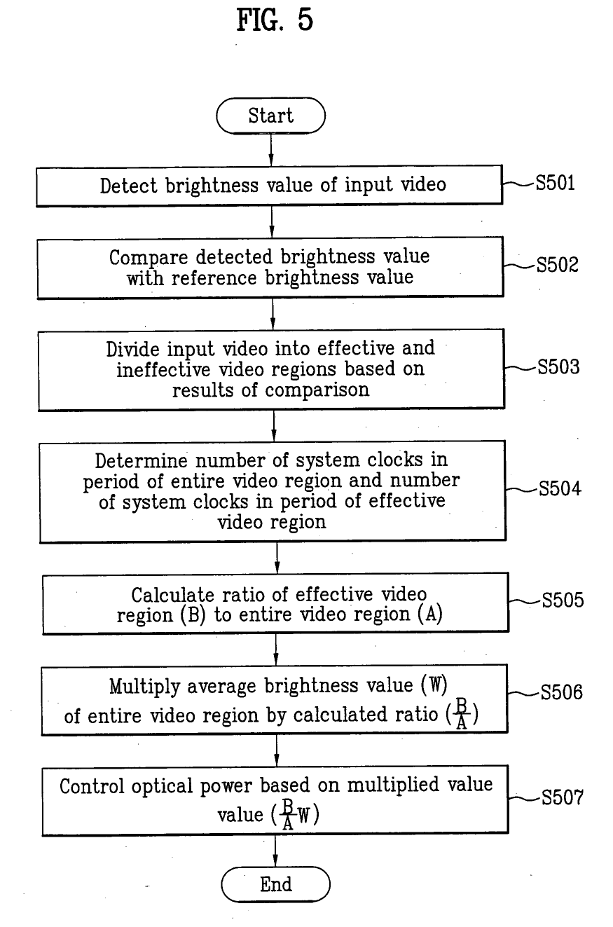

FIG. 5 is a flow chart explaining a method for controlling the projection type display device in accordance with a second embodiment of the present invention. When a video signal from a broadcasting station or from an external appliance is input, the controller 304 detects the brightness value of the received video signal (S501), and compares the detected brightness value with a reference brightness value (S502), as in the first embodiment.

If the brightness value of the video signal associated with a pixel or frame is not lower than the reference brightness value, the controller 304 determines that the pixel or frame is an effective video region. On the other hand, if the brightness value of the video signal associated with the pixel or frame is lower than the reference brightness value, the controller 304 determines that the pixel or frame is an ineffective video region. Thus, the controller 304 determines effective and ineffective video regions based on the brightness value of the video signal (S503).

The controller 304 also determines the number of vertical synchronizing signals V-sync generated during input of a video signal having a brightness value lower than the reference brightness value, to determine the pixels or frames of the video signal as ineffective video regions only when the number of the vertical synchronizing signals V-sync is higher than a predetermined value.

After the determination of the effective and ineffective video regions, the controller 304 determines the number of system clocks system₁₃ CLK generated in the period of the effective video region and the number of system clocks system₁₃ CLK generated in the period of the ineffective video region (S504). Using the determined number of system clocks system₁₃ CLK in the period of the effective video region and the determined number of system clocks system₁₃ CLK in the period of the ineffective video region, it is also possible to determine the number of system clocks system₁₃ CLK in the total video period.

As shown in FIG. 3, the controller 304 outputs a number of system clocks system₁₃ CLK in one period (one frame) of vertical synchronizing signals Vsync. Vertical scan lines or horizontal scan lines are supplied to the panel 307 in accordance with the system clocks system₁₃ CLK, respectively. Accordingly, if the number of system clocks system₁₃ CLK generated during the period of the effective video region and the number of system clocks system₁₃ CLK generated during the period of the ineffective video region are determined, the number of vertical or horizontal scan lines can then be determined. Therefore, it is possible to determine the size of the effective video region and the size of the ineffective video region.

The controller 304 then determines the ratio of the effective video region to the entire video region based on the number of system clocks system₁₃ CLK generated during the period of the effective video region and the number of system clocks system₁₃ CLK generated during the period of the ineffective video region (S505). The controller 304 can also determine the ratio of the effective video region to the ineffective vide region.

The present invention provides an example of a proportion equation for production of a histogram using the number of system clocks, as follows:
A:W=B:X

where, “A” represents the number of system clocks in the total video period, “W” represents the histogram data value of the entire video, namely, the average brightness value of the entire video, “B” represents the number of system clocks in the period of the effective video region of the entire video (“B” may be represented by “A (the number of system clocks in the total video period)—C (the number of system clocks in the period of the ineffective video region)”, and “X” represents a new histogram data value.

The proportion equation may be expressed as follows:

$$X = \frac{BW}{A} = ( 1 - \frac{C}{A} ) W$$

Thus, the new histogram data value X varies depending on the ratio B/A, namely, the ratio of the number of system clocks in the period of the effective video region, B, to the number of system clocks in the total video period, A. For example, when the size of the effective image region increases, the new histogram data value X is increased. On the other hand, when the effective image region has a reduced size, the new histogram data value X is decreased.

The new histogram data value X also varies depending on the ratio C/A, namely, the ratio of the number of system clocks in the period of the ineffective video region, C, to the number of system clocks in the total video period, A. For example, when the size of the ineffective image region increases, the new histogram data value X is decreased. On the other hand, when the ineffective image region has a reduced size, the new histogram data value X is increased.

The controller 304 calculates the ratio of the effective video region to the entire video region based on the number of system clocks. In order to obtain the new histogram data value X, the controller 304 multiplies the histogram data value W of the entire video by the calculated ratio B/A (S506)

Thereafter, the controller 304 controls the optical power of the optical power controller 305 based on the calculated new histogram data X (S507). For example, when the new histogram data value X increases, the controller 304 increases the optical power of the optical power controller 305. On the other hand, when the histogram data value X decreases, the controller 304 decreases the optical power of the optical power controller 305.

As apparent from the above description, in accordance with the present invention, input video is divided into an effective video region and an ineffective video region so that the brightness of the video is controlled based on the average brightness value of the effective video region or the size of the effective video region. Accordingly, it is possible to prevent a reduction in the brightness of the video caused by the ineffective video region. In accordance with the present invention, it is also possible to appropriately control the brightness of video in accordance with diverse display modes.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a projection type display device, comprising the steps of:
determining effective and ineffective video regions of video based on a brightness of an input video signal;
calculating an average brightness value of the effective video region; and
controlling an optical output of the projection type display device based on the calculated average luminance value.

2. The method according to claim 1, wherein the step of determining the effective and ineffective video regions of video based on the brightness of the input video signal comprises the steps of:
comparing the brightness of the video signal with a reference brightness for each pixel of the video signal; and
determining the pixel to be an effective video region or an ineffective video region, based on the results of the comparison.

3. The method according to claim 1, wherein the step of determining the effective and ineffective video regions of video based on the brightness of the input video signal comprises the steps of:
comparing an average brightness value of each frame of the video signal with a reference brightness; and
determining the frame to be an effective video region or an ineffective video region, based on the results of the comparison.

4. The method according to claim 1, wherein the step of determining the effective and ineffective video regions of video based on the brightness of the input video signal comprises the steps of:
sampling brightness values of a part of pixels in each frame of the video signal;
comparing the brightness values of the sampled pixels with a reference brightness; and
determining the frame to be an effective video region or an ineffective video region, based on the results of the comparison.

5. The method according to claim 4, wherein the step of comparing the brightness values of the sampled pixels with a reference brightness comprises the steps of:
calculating an average value of the brightness values of the sampled pixels; and
comparing the calculated average value with the reference brightness.

6. A projection type display device comprising:
an optical power controller for adjusting an optical power for display of video; and
a controller for determining effective and ineffective video regions of video based on a brightness of an input video signal, and controlling the optical power of the optical power controller based on an average brightness value of the effective video region.

7. The projection type display device according to claim 6, wherein the controller compares the brightness of the video signal with a reference brightness for each pixel of the video signal, and determines the pixel to be an effective video region or an ineffective video region, based on the results of the comparison.

8. The projection type display device according to claim 6, wherein the controller compares an average brightness value of each frame of the video signal with a reference brightness, and determines the frame to be an effective video region or an ineffective video region, based on the results of the comparison.

9. The projection type display device according to claim 6, wherein the controller compares brightness values of pixels sampled from each frame of the video signal with a reference brightness, and determines the frame to be an effective video region or an ineffective video region, based on the results of the comparison.

10. The projection type display device according to claim 9, wherein the controller calculates an average value of the brightness values of the sampled pixels, and compares the calculated average value with the reference brightness.

11. A method for controlling a projection type display device, comprising the steps of:
determining an effective video region of input video;
calculating a ratio of the effective video region to the entire region of the input video; and
controlling an optical power for display of the video, based on the calculated ratio.

12. The method according to claim 11, wherein the step of determining the effective video region of the video comprises the step of:
determining the effective video region based on the brightness of each pixel of the video.

13. The method according to claim 11, wherein the step of calculating the ratio of the effective video region to the entire video region comprises the step of:
calculating the ratio of the effective video region to the entire video region based on the number of system clocks in a period of the entire video region and the number of system clocks in a period of the effective video region.

14. The method according to claim 11, wherein the step of calculating the ratio of the effective video region to the entire video region comprises the step of:
calculating the ratio of the effective video region to the entire video region based on the number of vertical or horizontal scan lines in a period of the entire video region and the number of vertical or horizontal scan lines in a period of the effective video region.

15. The method according to claim 11, wherein the step of controlling the optical power for display of the video, based on the calculated ratio comprises the steps of:
multiplying an average luminance value of the entire region of the video by the calculated ratio; and
controlling the optical power for display of the video, based on a value obtained in accordance with the multiplication.

16. A projection type display device comprising:
an optical power controller for controlling an optical power for display of input video; and
a controller for determining an effective video region of the input video, calculating a ratio of the effective video region to the entire region of the input video, and controlling the optical power for display of the video, based on the calculated ratio.

17. The projection type display device according to claim 16, wherein the controller determines the effective video region based on the brightness of each pixel of the video.

18. The projection type display device according to claim 16, wherein the controller calculates the ratio of the effective video region to the entire video region based on the number of system clocks in a period of the entire video region and the number of system clocks in a period of the effective video region.

19. The projection type display device according to claim 16, wherein the controller calculates the ratio of the effective video region to the entire video region based on the number of vertical or horizontal scan lines in a period of the entire video region and the number of vertical or horizontal scan lines in a period of the effective video region.

20. The projection type display device according to claim 16, wherein the controller multiplies an average luminance value of the entire region of the video by the calculated ratio, and controls the optical power for display of the video, based on a value obtained in accordance with the multiplication.
